(19) United States
(12) Patent Application Publication
(10) Pub. No.: US 2009/0271032 A1
(43) Pub. Date: Oct. 29, 2009

(54) SYSTEM AND METHOD FOR CONTROLLING A MOVEMENT DEVICE

(75) Inventors: Sönke Kock, Västeras (SE); Per Norlin, Torslanda (SE)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD., Zurich (CH)

(21) Appl. No.: 12/426,504

(22) Filed: Apr. 20, 2009

Related U.S. Application Data
(63) Continuation of application No. PCT/EP2007/009085, filed on Oct. 19, 2007.

(30) Foreign Application Priority Data
Oct. 20, 2006 (EP) 06022017.5

(51) Int. Cl. G06F 19/00

(52) U.S. Cl. 700/245

(57) ABSTRACT

A system for controlling a movement device is disclosed. The system includes a movement device with a tool provided on the movement device, a movement device controller, a safety controller, a tool maintenance station and a movement detection unit for calculating a position of the movement device in the safety controller. The system includes a position detection module for generating a signal corresponding to a positioning of the tool in the tool maintenance station, which signal is made available to the safety controller by a transmission unit for the signal.

### RELATED APPLICATIONS

This application claims priority under 35 U.S.C. §119 to EP Application 06022017.5 filed in Europe on Oct. 20, 2006, and as a continuation application under 35 U.S.C. §120 to PCT/EP2007/009085 filed as an International Application on Oct. 19, 2007 designating the U.S., the entire contents of which are hereby incorporated by reference in their entireties.

### TECHNICAL FIELD

The disclosure relates to movement devices and movement device controllers. In particular, the disclosure relates to safety devices for robots and their control. Specifically, the disclosure relates to a system for controlling a movement device and to a method for controlling a movement device with a safety controller.

### BACKGROUND INFORMATION

Robots are increasingly undertaking tasks involved in industrial production. On the one hand, robots are used for positioning components in a predetermined place. On the other hand, tool robots, which are equipped with welding heads, painting nozzles or laser cutting devices, are also increasingly being used. The robots thereby carry out movements preprogrammed with the given axes. The area in which these robot movements are performed would represent a considerable safety risk for personnel entering the area of movement. However, it may be necessary to enter the danger area of the robot for maintenance work, manual guidance of the robots or other activities. It is generally stipulated that certain safety requirements have to be met for the operation of robots.

For this purpose, robots are, for example, equipped with safety position switches, a safety controller or other devices which monitor the position of a robot.

This may involve safety controllers processing the information of rotary encoders (angle encoders) in order to determine the position of the robot. These rotary encoder measurements are taken from the motor side of the drive gear mechanism and the safety controller counts the revolutions of the motor in order to determine the position on the arm side. On the other hand, the robot controller calculates the revolutions with a rotary encoder that is likewise arranged on the motor side and a further revolution counter. It is often also the case that the same encoder but separate revolution counters are used for both controllers. For the safe operation of the robot, the rotary encoder of the safety controller and the rotary encoder of the robot controller can be synchronized with a position value or revolution value at certain, preferably regular, intervals. This involves, for example, checking the rotary encoder of the safety controller for its correct position calculation, in that it is synchronized with such a position. However, the time involved for this safety feature can reduce the productivity of the installation, since the time for the synchronization is added to the cycle time.

### SUMMARY

A system for controlling a movement device is disclosed, comprising: a movement device with a tool provided on the movement device; a movement device controller; a safety controller; a tool maintenance station; a movement detection unit in the safety controller for determining a position of the movement device; and a position detection module for generating a signal corresponding to a positioning of the tool in the tool maintenance station and provided with a transmission unit for transmitting the signal to the safety controller.

A method for controlling a movement device with a safety controller is disclosed, comprising: moving the movement device to a maintenance position of a maintenance station for a tool fastened to the movement device; transmitting a maintenance signal to a control component of the movement device within a time period from assuming the maintenance position to leaving the maintenance position; transmitting a synchronization signal for a safety controller within the time period from assuming the maintenance position to leaving the maintenance position; synchronizing the safety controller; and moving the movement device from the maintenance station after a signal for successful synchronization.

### BRIEF DESCRIPTION OF THE DRAWINGS

The disclosure and advantageous configurations, improvements and details are to be explained and described more specifically on the basis of the exemplary embodiments that are represented in the following figures.

FIG. 1 shows a schematic representation of an exemplary installation control during a synchronization of a safety controller,

FIG. 2 shows a schematic representation of an exemplary movement-device system component which communicates with a safety controller in the course of maintenance work,

FIG. 2a shows another schematic representation of an exemplary movement-device system component which communicates with a safety controller in the course of maintenance work,

FIG. 3 shows another schematic representation of an exemplary movement-device system component which communicates with a safety controller in the course of maintenance work,

FIG. 4 shows another schematic representation of an exemplary movement-device system component which communicates with a safety controller in the course of maintenance work, and

FIG. 5 shows a flow diagram of an exemplary embodiment of the robot controller.

### DETAILED DESCRIPTION

Exemplary embodiments disclosed herein are directed to improved systems for robots, robot controllers and improved robot control methods. The intention here is to use non-productive time of the installation more effectively, without neglecting safety aspects.

With respect to the aforementioned, a system for controlling a movement device and a movement device (for example a robot or a movement axis) with a safety controller are disclosed. These comprise a movement device with a tool provided on the movement device, a movement device controller, a safety controller, a tool maintenance station, wherein a position detection module is provided for generating a signal corresponding to a positioning of the tool in the tool maintenance station and has a transmission means for the signal to the safety controller.

Such a device or such a system allows a desired or required synchronization of the safety controller to be carried out during maintenance work that is independent of the synchronization of the safety controller. In this case, a value of the position of the movement device that is detected for the position determination by a movement detection unit, for example a rotary encoder, is matched with an actual value in the safety controller.

According to one exemplary embodiment, it is possible that the transmission unit of the position detection module is formed so as to generate the signal from a maintenance signal for the movement device. According to another exemplary embodiment, the position detection module has a first and second position-detection module component, the first position-detection module component being a position detector and the second position-detection module component being an element triggering the position detector.

Accordingly, an initiation signal for the synchronization can be generated from a signal for the maintenance that is independent of the synchronization, or, additionally or alternatively, a mechanism for the detection of the tool position in the maintenance station may be provided.

According to one exemplary embodiment, a mechanism for the detection of the tool position in the maintenance station may be constructed in such a way that the position detector is provided at a fixed location with respect to the tool maintenance station or at the tool maintenance station, and the element triggering the position detector is provided on the movement device or on the tool. Alternatively, the position detector may be provided on the movement device or on the tool, and the element triggering the position detector may be provided at a fixed location with respect to the tool maintenance station or at the tool maintenance station.

The position detector can assume one of the following configurations: a button, a switch, a proximity sensor, a light barrier, a distance meter, and/or a light detector, for example a photocell.

According to further exemplary embodiments, the transmission unit for the transmission of the synchronization signal may transmit the signal to the safety controller over a cable or by wireless transmission. Within the scope of the exemplary embodiments described here, the movement device can be a robot.

Furthermore, with respect to the aforementioned, a method for controlling a movement device with a safety controller is provided. The method comprises the moving of the movement device into a maintenance position for the maintenance of a tool, the transmitting of a maintenance signal to a control component of the movement device within a time period from assuming the maintenance position to leaving the maintenance position, the transmitting of a synchronization signal for a safety controller within the time period from assuming the maintenance position to leaving the maintenance position, the synchronizing of the safety controller, and possibly the moving of the movement device from the maintenance station after a signal for successful synchronization.

According to various exemplary embodiments, a maintenance signal can be transmitted at the beginning and/or end of the time period of the maintenance or, additionally or alternatively, during the time period of the maintenance, that is to say at any desired point in time within the maintenance interval.

According to a further exemplary embodiment, the synchronizing of the safety controller comprises comparing the number of revolutions of the motor of an axis that is registered by the safety controller with an actual number of revolutions of the motor of the axis, which can be determined on the basis of the predeterminable position, and assessing a deviation with respect to a predetermined tolerance.

Since the tool fastened to the movement device can be maintained within the time period from assuming the maintenance position to leaving the maintenance position, the synchronization of the safety controller does not require any additional time.

According to one exemplary embodiment, the synchronization signal may be generated from the maintenance signal. According to another exemplary embodiment, additionally or alternatively, the synchronization signal may be generated by a detection mechanism which is activated in the maintenance position and/or by assuming the maintenance position.

According to yet a further exemplary embodiment, a time for a cycle of the movement device, including maintenance of the tool fastened to the movement device, is not less than a time for a cycle of the movement device, including maintenance of the tool fastened to the movement device, and the synchronization of the safety controller.

Exemplary embodiments and details of the disclosure are described with reference to robots. However, the exemplary embodiments may be used for any form of movement device, in particular movement devices for processing equipment. The movement devices may be, for example, robots or else linear axes or other handling systems that can be moved with one or more axes.

In connection with the exemplary embodiments presented here, reference is made to tools on a movement device, for example a robot. Exemplary tools that are mounted on a movement device are welding heads for spot welding, welding torches for arc welding, laser heads for cutting, welding and/or cleaning, painting nozzles, grippers or hybrid heads, which combine a number of the aforementioned tools.

In particular in the case of the use of tool robots, the tools of the robot must undergo maintenance work at regular intervals. Exemplary maintenance work includes, for example, the forming of the tip in the case of spot welding, the cleaning of the welding torch in the case of arc welding, the cleaning of the laser head in the case of laser welding or other laser applications, the cleaning of spray nozzles or other maintenance work for tools on machine tools. Handling robots also undergo regular maintenance, for example for the handling units or grippers. Maintenance may also include the measuring of a tool center point, for example with the aid of an optical sensor.

In the course of maintenance work, the robots are moved to a maintenance station, so that the corresponding maintenance work can be carried out there.

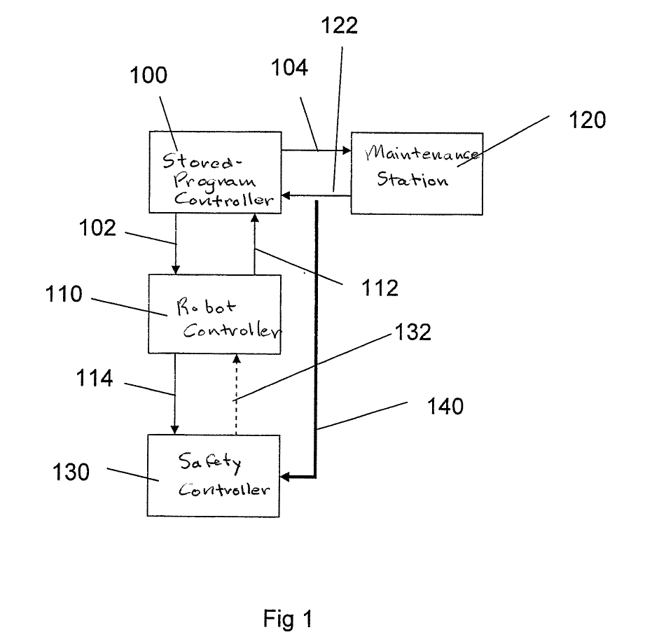

FIG. 1 shows a schematic representation of an arrangement according to an exemplary embodiment described herein. A stored-program controller (SPC, programmable logic controller (PLC)) 100 gives the robot controller 110 a signal to go to the maintenance station 120. The robot controller 110 transmits a signal 112 to the stored-program controller 100 when the robot controller has brought the robot arm into position in the maintenance station 120. The SPC signals by means of the signal 104 that the maintenance station 120 can carry out the corresponding maintenance work.

According to various exemplary embodiments, the maintenance work may, for example, constitute the forming of the tip in the case of spot welding, the cleaning of the welding torch in the case of arc welding, the cleaning of the laser head in the case of laser welding or other laser applications, or the cleaning of spray nozzles.

According to the exemplary embodiment represented in FIG. 1, on the basis of the service signal 122 of the service station 120, a signal 140 is transmitted to the safety controller 130. The signal 140 signals that a synchronization of the safety controller can be carried out. According to one exemplary embodiment, the safety controller is synchronized with a stored position value, which is defined by a predetermined position within the maintenance station.

On the basis of the actual position then known, the safety controller 130 is able to check whether there is a safety-relevant deviation between the desired position and the position calculated by the safety controller 130.

A synchronization of the safety controller is also necessary, for example, after the switching on of the safety controller, in order to generate a current stored value, which is matched with the fixed maintenance position.

According to a further exemplary embodiment, as represented in FIG. 1, the position value calculated by the robot controller is transmitted by means of the position signal 114 from the robot controller 110 to the safety controller 130. This additionally allows testing of the robot controller to take place. It can also be envisaged that the calculated position value is transmitted by means of the position signal 114 as an alternative specification of the actual position of the safety controller 130.

Within the course of the safety monitoring, there are then two safety-relevant tests. Firstly, whether the value calculated by the safety controller deviates from the stored actual position in which the tool is located. If a deviation is detected, the robot can be inhibited from further movement. Secondly, whether the value calculated by the robot controller deviates from the stored actual position in which the tool is located. If the robot controller or the SPC has not already instigated a inhibiting action due to a collision of the robot with the tool station or an unreceived maintenance position signal, the safety controller may inhibit the robot from further movement (for example in the case of deviations that are small but lie outside a tolerance).

If a safety-relevant deviation occurs, the safety controller sends in response a stop signal 132 to the robot controller 110. A safety-relevant deviation can, for example, be assumed if the number of revolutions counted by the safety controller deviates by at least one revolution from the number of revolutions corresponding to the actual position. Since the safety controller records the measurement data on the motor side of the drive gear mechanism, the tolerance value may also be a multiple of a revolution (for example two, three or four revolutions) or a fraction of a revolution, depending on the gear transmission. A comparison of the number of revolutions can in this case be carried out separately for each axis of the robot—depending on the form of the safety controller.

In the event that a deviation of the safety controller is merely within the limits of a predetermined tolerance, the safety controller can send an enabling command to the robot controller 110. This enabling command then gives the signal for the robot controller to continue. According to an exemplary embodiment, a practicable tolerance is a maximum difference between the actual position, which is predetermined by the actual position of the robot arm in the maintenance station 120, and a determined, in particular calculated, position, which is expected by the safety controller 130 on the basis of the rotary encoder signal, less than one motor revolution with respect to an axis in each case. Within the course of the synchronization, the safety controller 130 stores the new value and may, for example, also carry out a resetting of the running time monitoring to the next synchronization.

The revolution counting of the safety controller is therefore synchronized without any additional time being lost. A synchronization of the safety monitoring may be integrated in an existing procedure, without requiring additional non-productive time for this. In the course of maintenance in a maintenance station, a signal is sent to a safety controller. The safety controller then compares the current robot position and the synchronization position last stored. If a deviation is outside a predetermined tolerance, the robot may be stopped for safety reasons. Otherwise, normal operation can be continued.

According to one exemplary embodiment, on the basis of the positioning of the robot arm in the maintenance station, at least one operating signal is sent to the robot controller or the stored-program controller for securing the robot when the maintenance work starts, is being carried out or is reported as completed. Such a signal can be used to stop or proceed further with the program control of the robot.

According to one exemplary embodiment, a signal of the maintenance station which signals a beginning, continuation or completion of maintenance work and is sent to the robot controller or the SPC can be additionally sent to the safety controller in order to initiate a required or prescribed synchronization.

According to another exemplary embodiment, a synchronization signal may also be generated by an additional switch, which is, for example, actuated by the positioning of the robot arm in the maintenance station. According to a further exemplary embodiment, such a signal may also be triggered by a light barrier or a laser curtain. Furthermore, according to yet a further exemplary embodiment, it is possible to use a proximity sensor. Corresponding switching devices may also be fitted on the tool, the robot arm itself or other parts of the robot. An existing signal can be sent to the safety controller or an additional signal can be generated for the safety controller when the robot has been brought into the maintenance position.

Within the scope of the present disclosure, the maintenance position is to be understood as meaning a position which the robot goes to independently of safety-relevant events, for example, with respect to the synchronization of the safety controller at regular intervals and/or at least once within a predetermined time period, in particular at least once within 8 hours (a working shift), or any desired time interval. Depending, for example, on a safety requirement, a minimum interval may also be chosen to be smaller or greater.

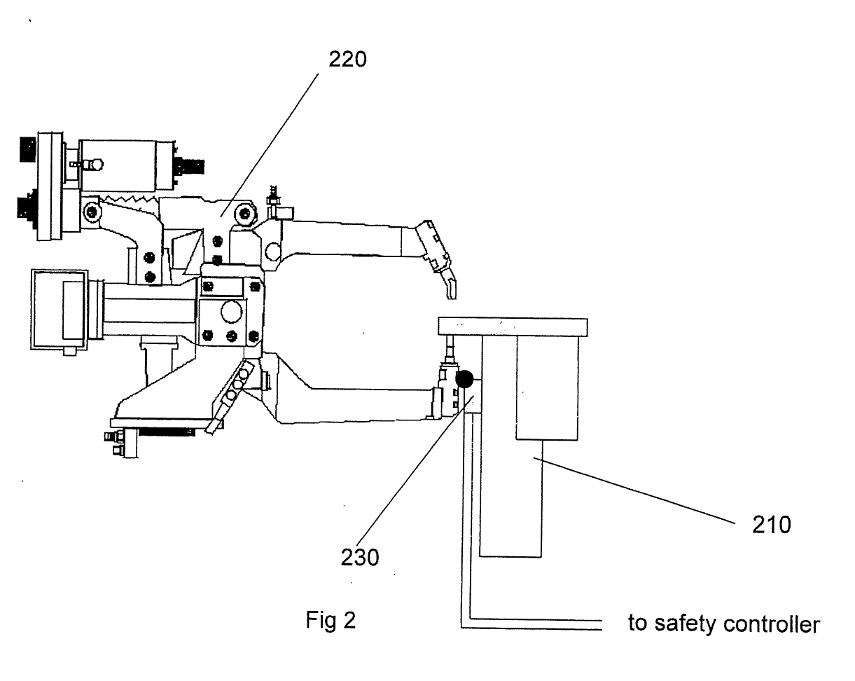

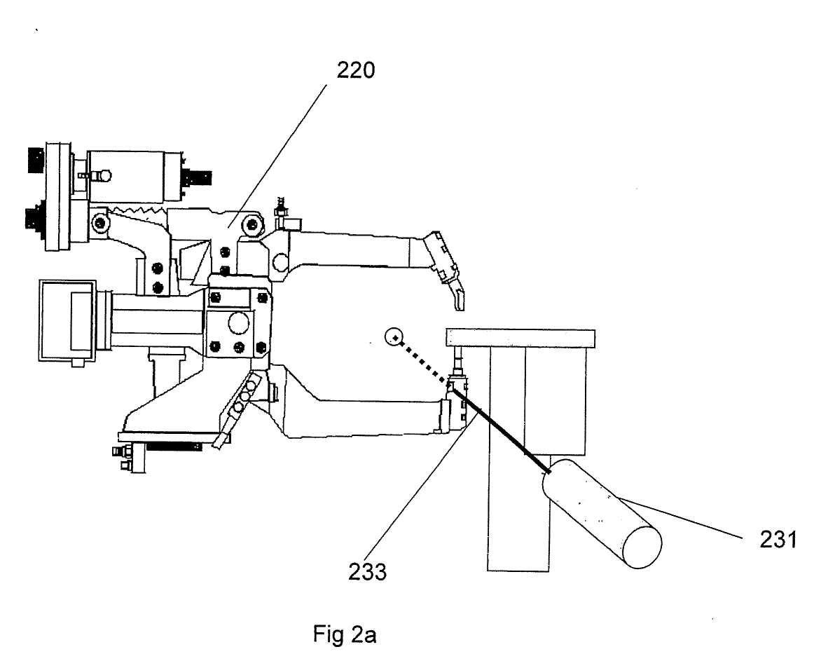

FIG. 2 shows an exemplary embodiment in which a robot tool 220 is positioned in a maintenance position at a tool maintenance station 210. In this position, the robot tool 220 triggers the switch 230. By being actuated by the tool 220, the switch 230 sends a signal to the safety controller. The synchronization signal instigates a synchronization of the safety controller that is required for the operation of the installation.

According to a further exemplary embodiment, the switch 230 may also be triggered by other parts of the robot than the tool 220. In the example, this may be part of the robot arm or a holder for the tool.

Furthermore, according to another exemplary embodiment, it is possible that the switch 230 is either activated by the direct contact with the robot arm or is a proximity sensor.

According to a further exemplary embodiment, represented in FIG. 2a, the tool 220 is in a tool maintenance station 210. In this position, a light beam 233 is interrupted by the robot tool 220, which is indicated by the dashed line. The interruption of the light beam has the effect of generating a signal to the safety controller for synchronization.

According to one exemplary embodiment, the light beam 233 is formed by a light barrier 231. According to a further exemplary embodiment, the light beam 233 may also be part of a laser curtain. According to further exemplary embodiments, the light beam may also be provided by a laser-based distance measurement (running time or triangulation).

According to a further exemplary embodiment, the light beam 233, which may for example be provided by a laser beam, may also be blocked by other parts of the robot than the tool 220. In the example, this may be part of the robot arm or a holder for the tool.

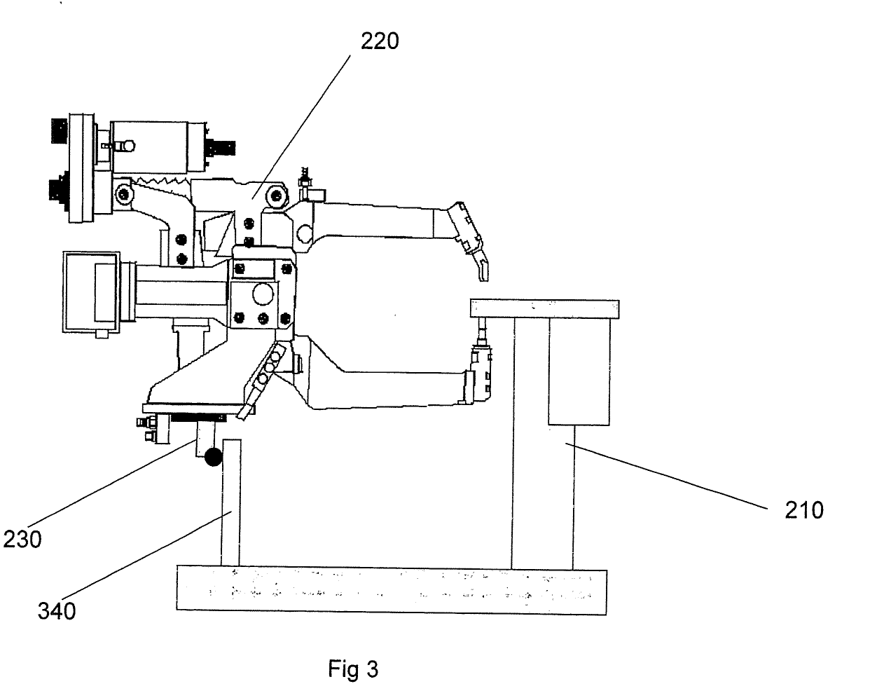

FIG. 3 shows an exemplary embodiment in which a switch 230 or button or a proximity sensor 230 is fitted on a tool 220. The tool 220 is in a maintenance position at the tool maintenance station 210. An actuating device 340, for example a plate, a pin or a similar part, is positioned near the maintenance station or at the maintenance station in such a way that the actuating device 340 activates the switch 230 when the tool 220 is in the maintenance position.

According to a further exemplary embodiment, the switch 230 may also be mounted on other parts of the robot than the tool 220. In the example, this may be part of the robot arm or a holder for the tool.

Furthermore, according to another exemplary embodiment, it is possible that the switch 230 is either activated by the direct contact with the actuating device 340 or is a proximity sensor.

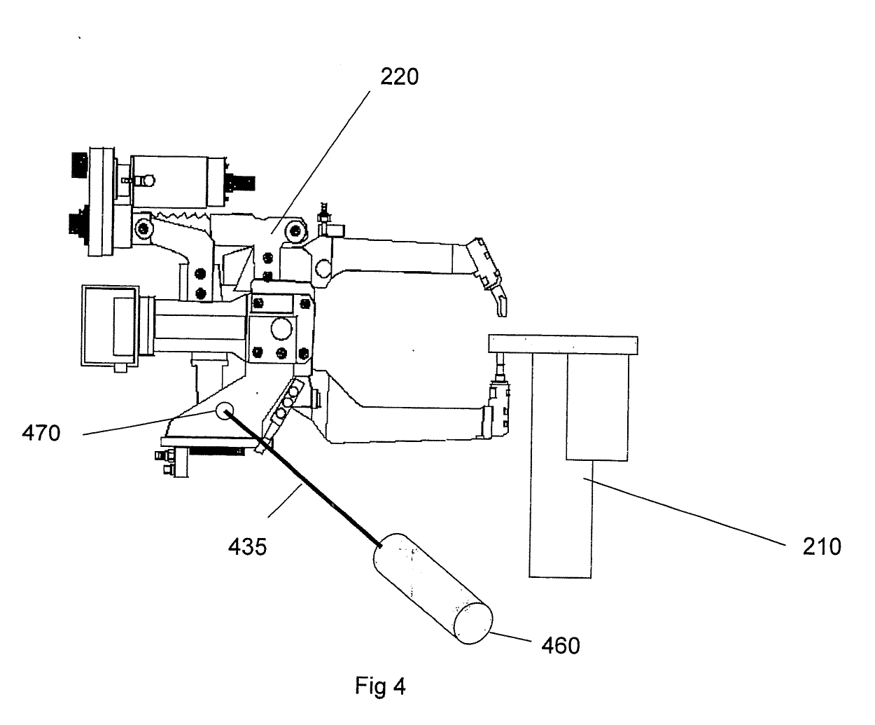

According to an exemplary embodiment represented in FIG. 4, a synchronization signal may also occur for a detector for a light signal. In FIG. 4, the tool 220 is in the maintenance position with respect to the tool maintenance station 210. When the tool that is mounted on a robot arm is in a predetermined position, a laser beam, for example a laser beam 435, which is emitted by an emitter 470, impinges on a detection unit 460. The emitter 470 may be, for example, a laser diode. The laser beam 435 impinges on the light receiver 460, so that the latter receives a signal, is activated and can send out a synchronization signal.

According to a further exemplary embodiment, a receiver for a light beam, for example a laser beam, may also be fitted on the tool 220, while a light beam emitter is fitted close to the maintenance station or at the maintenance station in such a way that the light beam impinges on the light receiver on the tool 220 when the tool is in the predetermined position.

According to the exemplary embodiments described above, a synchronization signal is generated by a device in connection with the maintenance station and transmitted to the safety controller. This transmission may take place over a cable. According to further exemplary embodiments, the transmission may also take place in a wireless manner.

Furthermore, the exemplary embodiments described above relate to synchronization signals which are transmitted either by the maintenance station itself or by additional switches that are activated when the tool is in the maintenance position. In this respect, switches or activation devices for switches that are mounted on the tool are described in the exemplary embodiments described above. According to other exemplary embodiments, the switches or sensors or the activation units for switches and sensors may also be fitted on the robot arm. For this purpose, a position on a robot arm can be used that is suitable for making a synchronization of all the axes of the robot possible. According to further exemplary embodiments, however, switches and sensors or actuating devices for switches and sensors may also be arranged in such a way that individual axes or all the axes of the robot can be synchronized separately.

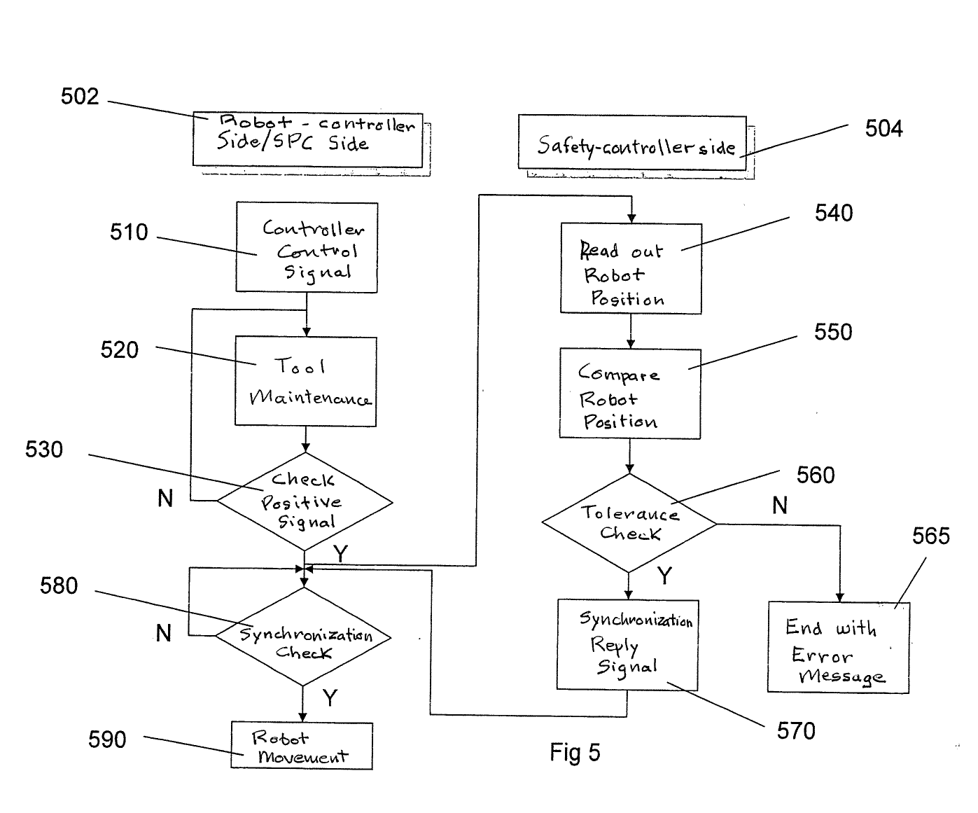

FIG. 5 shows an exemplary embodiment of a method for performing the synchronization of the safety controller. In FIG. 5, the method is divided into a robot-controller side/SPC side 502 and a safety-controller side 504. In step 510, a stored-program controller (SPC/PLC) or a robot controller gives a control signal to move the tool into the maintenance position. In step 520, the maintenance is carried out on the tool. In step 530, the method checks whether a positive signal with respect to the maintenance is received. If this is not the case, the process jumps back to step 520. In the case of a positive signal with respect to the maintenance position, a synchronization signal is sent to the safety controller, which in step 540 reads out the robot position. In step 550, the robot position is compared with the stored position. If a tolerance check in step 560 produces a deviation outside a predetermined tolerance, the sequence is ended in step 565 with an error message and further operation of the robot is stopped. In the case of a position comparison within a predetermined tolerance, the method is continued in step 570, in that a synchronization reply signal is sent, indicating successful synchronization. In step 580, the robot controller or the SPC checks whether a signal for successful synchronization has been received, and only continues further movement of the robot in step 590 after obtaining a positive signal.

By the exemplary embodiments described above, the safety controller can be synchronized without additional loss of time. A synchronization of the safety monitoring can be integrated in an existing procedure without having to take up additional non-productive time for this purpose. In the course of maintenance in a maintenance station, an additional signal is transmitted to the safety controller. A synchronization of the safety controller corresponding to the safety provisions can be realized without additional time being expended. As a result, productivity is increased and there is greater acceptance of the safety systems.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for controlling a movement device, comprising:
a movement device with a tool provided on the movement device;
a movement device controller;
a safety controller;
a tool maintenance station;
a movement detection unit in the safety controller for determining a position of the movement device; and
a position detection module for generating a signal corresponding to a positioning of the tool in the tool maintenance station and provided with a transmission unit for transmitting the signal to the safety controller.

2. The system for controlling a movement device as claimed in claim 1, wherein the transmission unit of the position detection module is used for generating the signal from a maintenance signal for the movement device.

3. The system for controlling a movement device as claimed in claim 1, wherein the position detection module has a first and second position-detection module component, the first position-detection module component being a position detector and the second position-detection module component being an element triggering the position detector.

4. The system for controlling a movement device as claimed in claim 3, wherein the position detector is provided at a fixed location with respect to the tool maintenance station or at the tool maintenance station, and the element triggering the position detector is provided on the movement device or on the tool.

5. The system for controlling a movement device as claimed in claim 3, wherein the position detector is provided on the movement device or on the tool, and the element triggering the position detector is provided at a fixed location with respect to the tool maintenance station or at the tool maintenance station.

6. The system for controlling a movement device as claimed in claim 3, wherein the position detector is an element from a group comprising the following elements: a switch, a proximity sensor, a light barrier, a distance meter and a light detector.

7. The system for controlling a movement device as claimed in claim 1, wherein the transmission unit transmits the signal to the safety controller by means of a cable.

8. The system for controlling a movement device as claimed in claim 1, wherein the transmission unit transmits the signal to the safety controller in a wireless manner.

9. The system for controlling a movement device as claimed in claim 1, wherein the movement device is a robot.

10. A method for controlling a movement device with a safety controller, comprising:
moving the movement device to a maintenance position of a maintenance station for a tool fastened to the movement device;
transmitting a maintenance signal to a control component of the movement device within a time period from assuming the maintenance position to leaving the maintenance position;
transmitting a synchronization signal for a safety controller within the time period from assuming the maintenance position to leaving the maintenance position;
synchronizing the safety controller; and
moving the movement device from the maintenance station after a signal for successful synchronization.

11. The method for controlling a movement device with a safety controller as claimed in claim 10, wherein, when synchronizing the safety controller, the safety controller compares a number of revolutions or position of an axis determined by the safety controller with a stored number of revolutions or position of the axis and assesses a deviation with respect to a predetermined tolerance.

12. The method for controlling a movement device with a safety controller as claimed in claim 10, wherein the tool fastened to the movement device is maintained within the time period from assuming the maintenance position to leaving the maintenance position.

13. The method for controlling a movement device with a safety device as claimed in claim 10, wherein the synchronization signal is generated from the maintenance signal.

14. The method for controlling a movement device with a safety controller as claimed in claim 10, wherein the synchronization signal is generated by a detection mechanism which is activated in the maintenance position.

15. The method for controlling a movement device with a safety controller as claimed in claim 14, wherein the detection mechanism is activated by at least one element from a group comprising the tool, the movement device, a maintenance station component and a light source.

16. The method for controlling a movement device with a safety controller as claimed in claim 10, wherein a time for a cycle of the movement device, including maintenance of the tool fastened to the movement device, is not less than a time for a cycle of the movement device, including maintenance of the tool fastened to the movement device, and the synchronization of the safety controller.

17. The method for controlling a movement device with a safety controller as claimed in claim 10, comprising: checking of a position value of the movement control device by the safety controller.

18. The system for controlling a movement device as claimed in claim 2, wherein the position detection module has a first and second position-detection module component, the first position-detection module component being a position detector and the second position-detection module component being an element triggering the position detector.

19. The system for controlling a movement device as claimed in claim 5, wherein the position detector is an element from a group comprising the following elements: a switch, a proximity sensor, a light barrier, a distance meter and a light detector.

20. The method for controlling a movement device with a safety controller as claimed in claim 11, wherein the tool fastened to the movement device is maintained within the time period from assuming the maintenance position to leaving the maintenance position.

21. The method for controlling a movement device with a safety device as claimed in claim 20, wherein the synchronization signal is generated from the maintenance signal.

22. The method for controlling a movement device with a safety controller as claimed in claim 21, wherein the synchronization signal is generated by a detection mechanism which is activated in the maintenance position.

23. The method for controlling a movement device with a safety controller as claimed in claim 22, wherein a time for a cycle of the movement device, including maintenance of the tool fastened to the movement device, is not less than a time for a cycle of the movement device, including maintenance of the tool fastened to the movement device, and the synchronization of the safety controller.

24. The method for controlling a movement device with a safety controller as claimed in claim 23, comprising: checking of a position value of the movement control device by the safety controller.
